(19) United States
(12) Patent Application Publication
(10) Pub. No.: US 2009/0092125 A1
(43) Pub. Date: Apr. 9, 2009

(54) METHOD AND APPARATUS FOR PROVIDING CUSTOMER CONTROLLED TRAFFIC REDISTRIBUTION

(76) Inventors: Gerald L. Hoover, Red Bank, NJ (US); Min Lu, Freehold, NJ (US); Jerry A. Robinson, Middletown, NJ (US); Smita Sheth, Marlboro, NJ (US)

Correspondence Address: AT&T CORP., ROOM 2A207, ONE AT&T WAY, BEDMINSTER, NJ, 07921, US

(21) Appl. No.: 11/866,855

(22) Filed: Oct. 3, 2007

(51) Int. Cl. H04L 12/28

(52) U.S. Cl. 370/351

(57) ABSTRACT

A method and apparatus for providing customer controlled traffic redistribution are disclosed. For example, the method determines one or more states of one or more Customer Premise Equipments (CPEs) at one or more customer sites periodically, wherein the one or more states are configured by a customer. The method then determines a network action for each of the one or more CPEs in accordance with the one or more states of the one or more CPEs, and routes traffic for the customer in accordance with the network action for each of the one or more CPEs.

The present invention relates generally to communication networks and, more particularly, to a method and apparatus for providing customer controlled traffic redistribution on packet networks, e.g., Internet Protocol (IP) networks, Voice over Internet Protocol (VoIP) networks, etc.

### BACKGROUND OF THE INVENTION

An enterprise customer may build a Virtual Private Network (VPN) by connecting multiple sites or users over a core network provided by a network service provider. The enterprise customer may request for a highly reliable service from the network service provider. For example, the enterprise customer may request multiple connections to multiple access routers and/or border elements to protect from access link failures. The network service provider may then provide multiple connections to a border element. For example, the network service provider may provide one connection to a primary customer site and another connection to a secondary customer site. Each customer site may then contain a Customer Premise Equipment (CPE) connected to a border element via an access network. When there is no failure, the customer traffic will be routed normally to the primary CPE. In case of a failure, either in the access link to the primary CPE or the primary CPE itself, the customer may notify the service provider to route traffic to the secondary CPE. However, during the time that it takes to switchover to the secondary site (CPE), calls may be lost. Furthermore, in case of scheduled customer CPE maintenance in the primary site, the customer may need to notify the network service provider in advance to make the secondary site the primary and to schedule a predetermined time for returning the traffic to the original primary site. The process to negotiate, schedule, and execute these manual changes may take a substantial amount of time, e.g., several hours.

### SUMMARY OF THE INVENTION

In one embodiment, the present invention discloses a method and apparatus for providing customer controlled traffic redistribution. For example, the method determines one or more states of one or more Customer Premise Equipments (CPEs) at one or more customer sites periodically, wherein the one or more states are configured by a customer. The method then determines a network action for each of the one or more CPEs in accordance with the one or more states of the one or more CPEs, and routes traffic for the customer in accordance with the network action for each of the one or more CPEs.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network in accordance with the current invention for providing customer controlled traffic redistribution;

FIG. 3 illustrates a flowchart of a method for providing customer controlled traffic redistribution; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for providing customer controlled traffic redistribution on packet networks, e.g., Internet Protocol (IP) networks, Voice over Internet Protocol (VoIP) networks, etc. Although the present invention is discussed below in the context of VoIP networks, the present invention is not so limited. Namely, the present invention can be applied for other packet networks such as Internet Protocol Television (IPTV) networks, cellular networks, and so on.

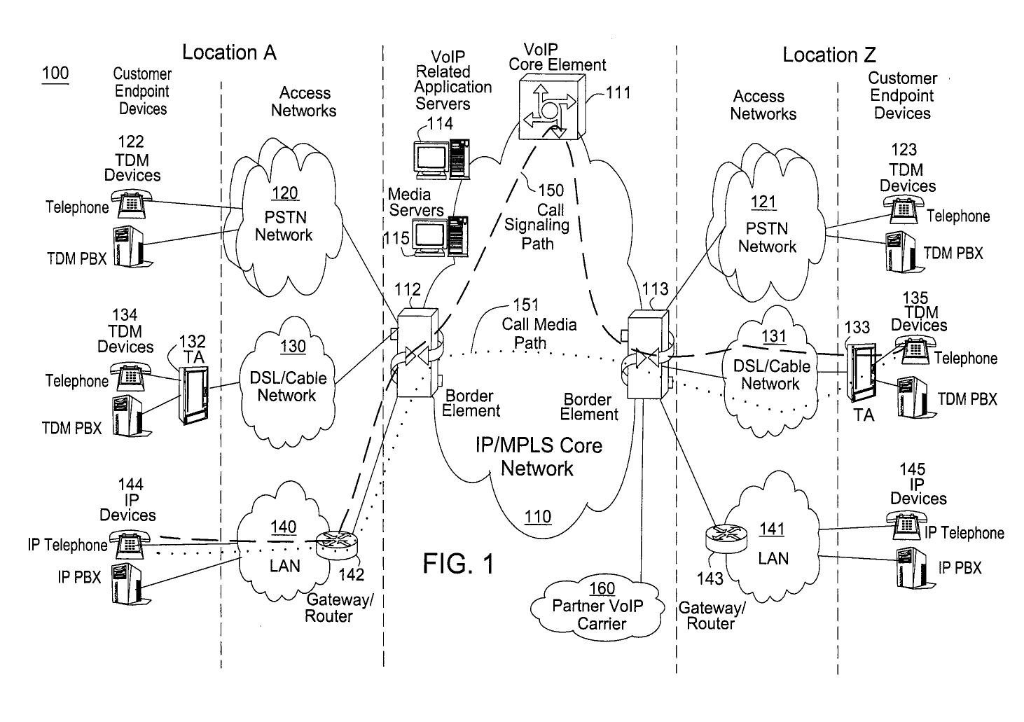

To better understand the present invention, FIG. 1 illustrates an exemplary network 100, e.g., a packet network such as a VoIP network related to the present invention. Exemplary packet networks include Internet protocol (IP) networks, Asynchronous Transfer Mode (ATM) networks, frame-relay networks, and the like. An IP network is broadly defined as a network that uses Internet Protocol to exchange data packets. Thus, a Voice over Internet Protocol (VoIP) network is considered an IP network.

In one embodiment, the VoIP network may comprise various types of customer endpoint devices connected via various types of access networks to a carrier (e.g., a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. The present invention is described below in the context of an illustrative VoIP network. Thus, the present invention should not be interpreted as limited by this particular illustrative architecture.

The customer endpoint devices can be either Time Division Multiplexing (TDM) based or IP based. For example, TDM based customer endpoint devices 122, 123, 134, and 135 may comprise TDM phones or Private Branch Exchanges (PBXs). IP based customer endpoint devices 144 and 145 may comprise IP phones or IP PBXs. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices may access VoIP services by using either a Public Switched Telephone Network (PSTN) 120, 121 or a broadband access network 130, 131 via a TA 132 or 133. IP based customer endpoint devices may access VoIP services by using a Local Area Network (LAN) 140 and 141 with a VoIP gateway or router 142 and 143, respectively.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and/or router 142. A packet based access network 130 or 131, such as DSL or Cable, when used together with a TA 132 or 133, is used to support TDM based customer endpoint devices.

The core VoIP infrastructure comprises of several key components, such as the Border Elements (BEs) 112 and 113, the VoIP Core Network Element 111, VoIP related Application Servers (AS) 114, and Media Server (MS) 115. The BE resides at the edge of the VoIP core infrastructure and interfaces with customers endpoints over various types of access networks. A BE is typically implemented as a Media Gateway and performs signaling, media control, security, and call admission control and related functions, e.g., as shown in supporting a call media path 151.

In one embodiment, the VoIP Core network element resides within the VoIP infrastructure and is connected to the BEs using the Session Initiation Protocol (SIP) over the underlying IP/MPLS based core backbone network 110. The VoIP Core network element can be implemented as a Media Gateway Controller, a softswitch or CSCF functions and performs network wide call control related functions as well as interacts with the appropriate VoIP service related servers when necessary. The VoIP Core network element may need to interact with various VoIP related Application Servers (AS) in order to complete a call that requires certain service specific features, e.g., performing call forwarding service or translation of an E.164 voice network address into an IP address and so on. For calls that originate or terminate in a different carrier, they can be handled through the PSTN 120 and 121 or the Partner IP Carrier 160 interconnections. Thus, a customer in location A using any endpoint device type with its associated access network type can communicate with another customer in location Z using any endpoint device type with its associated network type.

The above VoIP network is described to provide an illustrative environment in which data and voice packets are transmitted on communication networks. As discussed above, an enterprise customer may build a Virtual Private Network (VPN) to interconnect multiple customer sites and/or users over a network provided by a network service provider, where the enterprise customer may request for a highly reliable service from the network service provider. For example, the enterprise customer may request multiple connections to multiple access routers and/or border elements to protect from access link failures. The network service provider may then provide multiple connections via one or more border elements. Unfortunately, the process to negotiate, schedule, and execute manual changes between multiple customer sites may take a substantial amount of time, e.g., several hours.

In one embodiment, the current invention provides customer controlled traffic redistribution on packet networks. The method first enables the customer to set a state for each CPE site. In one embodiment, a CPE may be in an “active” state, a “standby” state or a “failure” state as described below. It should be noted that although three states are described below, the present invention is not so limited. Namely, the present invention can be adapted to any number of states in accordance with the requirements of a particular deployment.

An “active” state refers to a state in which from the network perspective, both the link between the CPE and the network and the CPE device itself are operating normally and are prepared to receive traffic.

A “standby” state refers to a state in which both, the link between the CPE and the network and the CPE device itself, are operating normally but the customer does not want the CPE site to handle any traffic and/or a certain class of traffic (e.g., a subset of the overall traffic). The service provider may then mark the route as “out of service” so that no traffic may be routed or certain type of traffic will not be routed to the CPE in the standby state.

A “failure” state refers to a state in which a CPE's ability to support traffic is severely degraded and/or has completely failed. For example, the link between the CPE and the network and/or the CPE device itself may have failed. In one example, the CPE may have software or a hardware failure and may be sending out error messages. In another example, the network may have detected a failure by either receiving multiple SIP error codes or by timeouts of multiple requests. In another example, an alarm may have been received by the service provider. The “failure” state is the state in which the customer and the service provider would like to address as soon as possible, e.g., by fixing the problem that is causing the failure state.

It should be noted that each of the state may comprise one or more sub-states. In one embodiment, an active state may contain a “normal” sub-state and a “temporary failure” sub-state. In a “normal” sub-state, traffic is routed to the CPE site and the traffic is processed by the CPE site normally. In a “temporary failure” sub-state, the “active” CPE site may temporarily be unable to service one or more calls, where such temporarily failed calls may be rerouted to other CPE sites that are in the “normal” sub-state using an automatic rerouting capability in the service provider's network. The temporary failure may occur momentarily and may clear up on its own. For example, the temporary failure may be due to congestion and may correct itself without requiring any action from the customer and/or service provider.

In one embodiment, the current invention allows the customer to dynamically configure CPE sites to accept or decline traffic based on the state and/or sub-state of the site. For example, a CPE site in the “active” state with a “normal” sub-state may be configured to continue accepting traffic. A CPE site in the “active” state with a “temporary failure” sub-state may be configured to continue accepting traffic with the understanding that any failed calls will be rerouted to another “active-normal” CPE site. A CPE site in the “standby” state may be configured to reject/decline traffic using SIP error codes, e.g., the CPE site responding with a SIP error code 603. A CPE site in the “failure” state may be configured to reject traffic, and also to generate an alarm.

In one embodiment, the service provider is able to determine the state of the CPE sites by pinging or sending requests, e.g., SIP Option requests, periodically to the CPE sites. Based on the state of the CPE sites (e.g., as received in responses to SIP Option requests) the service provider may perform different actions. Table 1 provides an illustrative list of actions that may be performed in accordance to responses to SIP Options requests.

TABLE 1
Exemplary list of actions

| Response to SIP Options | State of the | |
|---|---|---|
| Request | CPE Site | Network Action |
| 200 OK | Active state, | Route traffic according to the |
| | normal sub- | network routing algorithm to the |
| | state | CPE site. |
| 603 Decline | Standby state | Mark the route to the CPE site |
| | | as out-of-service and don't |
| | | route any traffic to the CPE site. |
| Request timeouts and/or | Active state, | Route traffic according to the |
| 4xx, 5xx, other 6xx (other than | with temporary | network routing algorithm to the |
| 603) messages are received in | failure sub-state | CPE site. However, failed calls |
| response to some requests, but | | may be rerouted to other CPE |
| the number of said responses | | sites that are in active-normal state. |
| and/or timeouts is below a | | |
| predetermined threshold. | | |
| Request timeouts and/or | Failure state | When the threshold is reached, |
| 4xx, 5xx, other 6xx (other than | | the network service provider |
| 603) messages are received in | | may receive an alarm. The |
| response to some requests, and | | service provider may then mark |
| the number of said responses | | the route as out-of-service and |
| and/or timeouts exceeds a | | no traffic is routed to the CPE |
| predetermined threshold. | | site. |

If the response to SIP Options request is a 200 OK response, the CPE Site State is deemed to be in the “active” state. The sub-state is deemed to be “normal.” Traffic may then be forwarded to the CPE site in accordance to the routing algorithm. If the response to the SIP Options request is a 603 (Decline) response, the CPE site state is deemed to be in the “standby” state and it is marked as out-of-service. The network may not forward traffic to the CPE site.

If a few request timeout or a few 4xx, 5xx, 6xx (other than 603) are received, the CPE site may have a temporary failure. The notation “xx” in 4xx, 5xx, 6xx stands for any value other than expressly excluded. For example, “503” is an allowed code for temporary failure while “603” is not. It should be noted that the present invention is not limited to any particular codes that are used to communicate the states of the CPE sites. Namely, the service provider and/or the customer may determine the error code/codes to be used. The network may continue to route traffic to the CPE site with the temporary failure state, however failed calls may be rerouted to other CPE sites in “active” state with “normal” sub-state.

The number of responses (timeout, 4xx, 5xx, or 6xx) that may be considered as “few” may be set as a predetermined threshold. For example, a threshold may be established from statistical knowledge of such responses per time interval. For example, it may be statistically acceptable to receive 10 timeout responses in a 10 minute interval (e.g., deeming this condition as an active-temporary failure state) but may be excessive for a 1 minute interval (e.g., deeming this condition as a failure state). Thus, whether a CPE site is deemed to be in an active-temporary failure state or a failure state is premised on the number of timeouts and/or negative responses received in a given time period. Such thresholds can be determined statistically, e.g., for a particular customer, for a particular time of the day and so on. Thus, when the threshold for the “failure” state is reached, the CPE site may be marked as “out-of-service” and the network may stop forwarding traffic to the CPE site. Furthermore, the network service provider may receive one or more alarms associated with detection of the “failure” state, and the service provider may, in turn, notify the customer of the detected condition for the affected CPE site.

In one embodiment, the current invention may be extended to contain more states. For example, the failure state may be further refined to provide partial failures and/or resource specific failures. For example, a CPE site may be degraded but is still able to handle some classes of services under the partial failure. In one implementation, different error codes may be used to distinguish among sub-states and specific resources that may not be available. For example, the network may then send other traffic to a CPE site (other than those related to the specific resources that are not available or supported) based on the error codes. For example, if a CPE site can handle any other traffic other than teleconference related traffic, then the CPE site will respond with a specific error code that is associated with a restriction on receiving teleconferencing traffic.

In one embodiment, the customer may bring up a standby site to carry the traffic load on behalf of a failed site. In one embodiment, the customer may manually remove the SIP error code used to decline traffic from the CPE interface that is in standby state. As a result, the new CPE site may be able to carry the traffic. For example, when the network checks the state of the standby CPE site periodically (e.g., every minute, every five minutes, and so on) by sending SIP Option messages, it may detect the state change in the standby CPE site. The routing device in the network may then forward traffic to the newly activated customer site. The benefit of this approach is that the customer is in control of how traffic will be handled in a prompt and dynamic manner in terms of which CPE sites will be used.

Note that network continues to send SIP option requests to determine the CPE state regardless of the last known state of the CPE site. For example, a SIP option request will be continually sent to a CPE site having a last known status of a “failure” state to determine whether the CPE site has recovered. When the failure condition is removed (e.g., the periodic SIP Option request detects that the failure condition has cleared), the CPE site may be deemed to have return to the “active” state.

In one embodiment, if the customer needs an active site to stop receiving traffic, it may configure the CPE site to the “standby” state by sending a SIP code 603 in response to SIP Options requests to reject/decline traffic to the CPE site. The service provider's network may then detect that the CPE site is in the “standby” state and terminate forwarding traffic to the CPE site.

In one embodiment, any routing method may be implemented in conjunction with the current method for distributing traffic among various CPE sites in the “active” state. For example, a round robin routing method, a percentage routing method, and nested routing method, and so on may be used.

In one embodiment, the current method may distribute traffic to one or more networks to increase the rate of call completion. For example, if a SIP capable CPE site is in a “failure” state, a call may be completed at another customer site that may not be SIP capable. The SIP capable CPE site may send SIP error code 603 such that the network forwards the traffic to the customer site without SIP capability.

In one embodiment, the CPE site may contain multiple customer devices with one CPE device acting as an interface to the network, and each of the multiple customer devices may provide their own state. For example, a CPE site may contain 10 customer endpoint devices interacting with the network through one customer router. The customer router may then pass along the states of each of the 10 customer endpoint devices to the network. This embodiment may also be applied in networks where a customer may have one access link for multiple users.

Those skilled in the art would realize the error codes sent by a CPE site may be determined among the customer and the network service provider. Hence, the SIP error codes 603, 503, etc. discussed above are provided only as illustrative examples and should not be interpreted as limitations to the present invention.

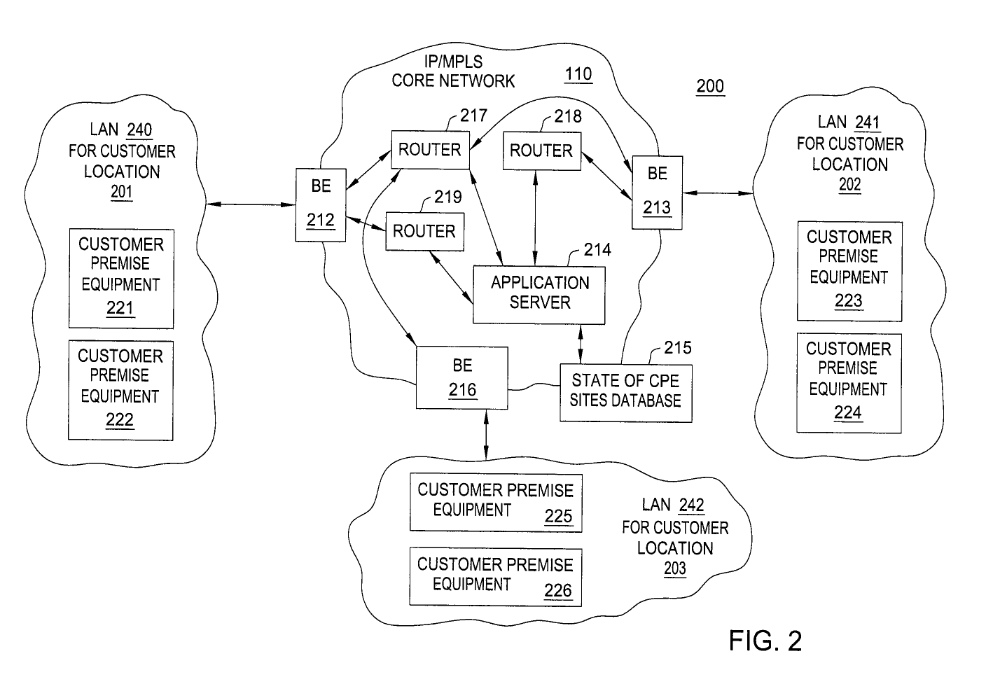

FIG. 2 illustrates an exemplary network 200 in accordance with one embodiment of the current invention for providing customer controlled traffic redistribution. For example, the customer may have a virtual private network interconnecting sites 201, 202 and 203, where e.g., LANs 240, 241 and 242 are established at customer sites 201, 202 and 203, respectively. The LANs 240, 241 and 242 are used to enable users at each site to access services in the IP/MPLS core network 110. LAN 240 is connected to the IP/MPLS core network 110 through a border element 212. LAN 241 is connected to the IP/MPLS core network 110 through a border element 213. LAN 242 is connected to the IP/MPLS core network 110 through a border element 216. Customer Premise Equipment (CPE) 221 and 222 in customer location 201, CPEs 223 and 224 in customer location 202, and CPEs 225 and 226 in customer location 203 are utilized for implementing the customer controlled traffic redistribution of the current invention. In one embodiment, the IP/MPLS core network 110 contains an application server 214 for interacting with VPN customers and providing customer controlled traffic redistribution. The IP/MPLS core network 110 also contains a database 215 for recording the states and/or sub-states of CPE sites. Traffic is routed among BEs 212, 213 and 216 through various routers 217-219.

In one embodiment, the customer dynamically configures the states and/or sub-states of CPEs 221-226 in accordance with the customer's preference. In one example, the customer may configure all the CPEs to be in the “active” state. In another example, the customer may redistribute traffic to different customer sites based on the time of day. Table 2 provides an exemplary configuration based on time of day.

TABLE 2
An Exemplary Configuration

| Time of day | |
|---|---|
| (EST) | Configuration |
| 4:00 AM-8:00 AM | CPEs 223 and 224 are “active”, |
| | all other CPEs are in “standby.” |
| 8:00 AM-2:00 PM | CPEs 223, 224, 225 and 226 are |
| | “active”, |
| | all other CPEs are in “standby.” |
| 2:00 PM-6:00 PM | All CPEs (221-226) are active. |
| 6:00 PM-12:00 AM | CPEs 221, 222, 225 and 226 are |
| | “active”, |
| | all other CPEs are in “standby.” |
| 12:00 AM-4:00 AM | CPEs 221 and 222 are “active”, |
| | all other CPEs are in “standby.” |

In one embodiment, the network service provider determines the state of each CPE site periodically. For example, the application server 214 may send messages, e.g., SIP Option messages, to CPEs 221-226 to retrieve the states/sub-states of each CPE. The application server 214 may store the states and/or sub-states of CPEs 221-226 in the database 215. If a change in state is received for a CPE, the network action for the CPE is updated according to the latest detected state of the CPE. The application server then determines the network action for each of the CPEs. For example, the application server may determine which one of the network actions in Table-1 is applicable for each of the CPEs 221-226. Traffic to the customer may then be routed in accordance with the network actions for each CPE. For example, if all the CPEs are in “active” state, traffic may be distributed according to the normal routing rules, e.g., percentage routing, round-robin routing, etc. In another example, if CPE 224 is in the “standby” state and all other CPEs are in the “active” state, then the network may mark the route to CPE 224 as “out-of-service” and send all traffic to the other CPEs in the “active” state (i.e. to CPEs 221, 222, 223, 225 and 226).

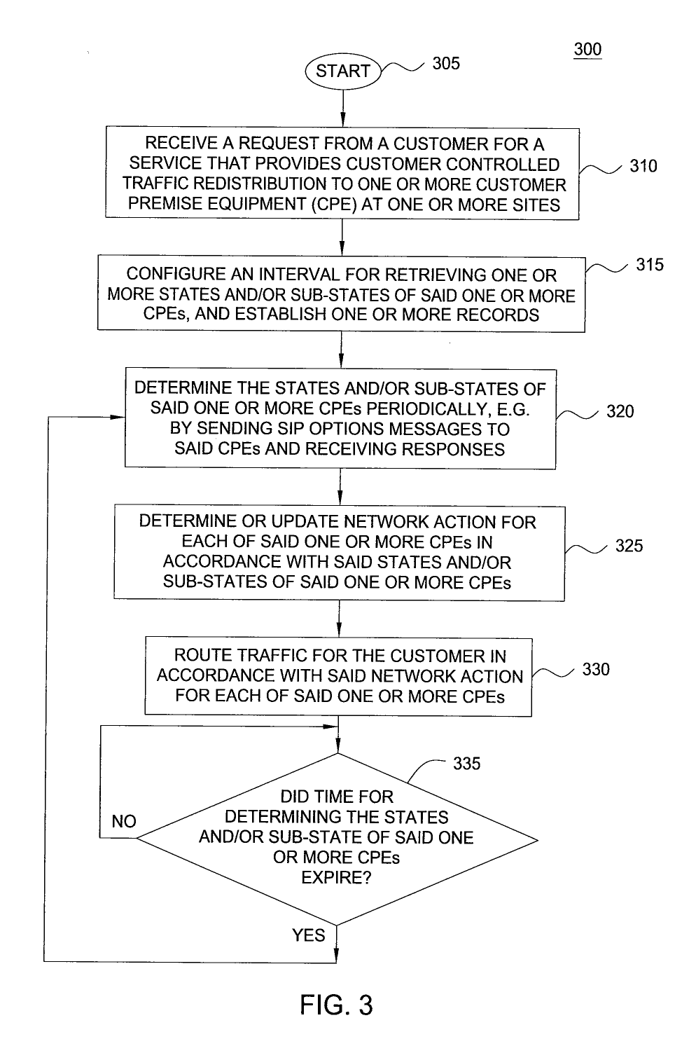

FIG. 3 illustrates a flowchart of one embodiment of the current method 300 for providing customer controlled traffic redistribution on packet networks. Method 300 starts in step 305 and proceeds to step 310.

In step 310, method 300 receives a request from a customer for a service that provides customer controlled traffic redistribution to one or more Customer Premise Equipment (CPE) at one or more sites. For example, a VPN customer may subscribe for a service (e.g., a subscriber service) that enables the customer to dynamically control traffic redistribution to one or more of CPEs at one or more sites.

In step 315, method 300 configures a time interval for retrieving one or more states and/or sub-states of the one or more CPEs, and establishes one or more records, e.g., one or more tables, for recording the retrieved information and a network action for each of the one or more CPEs. For example, the method may establish a database containing a list of CPEs, the last retrieved states/sub-states for each CPE, and the last known network action for each CPE. The information can be updated in accordance with a predetermined time intervals, e.g., every minute, every five minutes, every ten minutes, and so on.

In step 320, method 300 determines the states and/or sub-states of the one or more CPEs periodically, e.g., by sending SIP options messages to the one or more CPEs according to the time interval set in step 315. For example, if a customer configures the state of a CPE to be “standby” state, the method may receive a “603 decline” in response to the SIP options message.

In step 325, method 300 determines or updates network action for each of the one or more CPEs in accordance with the states and/or sub-states of the one or more CPEs. For the example above, if a customer reconfigures the state of a CPE from “standby” to “active”, the method updates the network action for the CPE such that traffic may be received by the active CPE.

In step 330, method 300 routes traffic for the customer in accordance with the network action for each of the one or more CPEs. For the example above, traffic may be routed according to the normal routing method, e.g., round robin, to each of the CPEs in accordance to the detected state of each CPE.

In step 335, method 300 determines whether or not the time for determining the states and/or sub-states of the one or more CPEs has expired. If the time has expired, the method proceeds back to step 320 to gather the latest states/sub-states of the CPEs. Otherwise, the method waits until the time expires.

It should be noted that although not specifically specified, one or more steps of method 300 may include a storing, displaying and/or outputting step as required for a particular application. In other words, any data, records, fields, and/or intermediate results discussed in the method can be stored, displayed and/or outputted to another device as required for a particular application. Furthermore, steps or blocks in FIG. 3 that recite a determining operation or involve a decision, do not necessarily require that both branches of the determining operation be practiced. In other words, one of the branches of the determining operation can be deemed as an optional step.

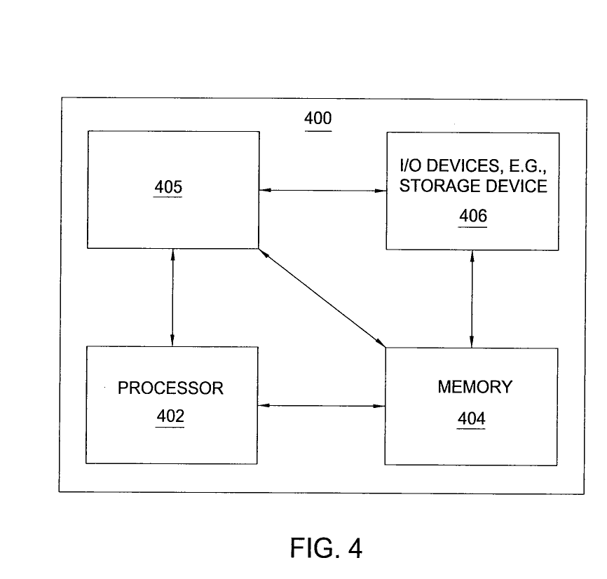

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for providing customer controlled traffic redistribution on packet networks, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 405 for providing customer controlled traffic redistribution on packet networks can be loaded into memory 404 and executed by processor 402 to implement the functions as discussed above. As such, the present method 405 for providing customer controlled traffic redistribution on packet networks (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing customer controlled traffic redistribution, comprising:
determining one or more states of one or more Customer Premise Equipments (CPEs) at one or more customer sites periodically, wherein said one or more states are configured by a customer;
determining a network action for each of said one or more CPEs in accordance with said one or more states of said one or more CPEs; and
routing traffic for the customer in accordance with said network action for each of said one or more CPEs.

2. The method of claim 1, wherein said one or more states comprise at least one of: an active state, a standby state or a failure state.

3. The method of claim 1, wherein said one or more states contain one or more sub-states.

4. The method of claim 3, wherein said one or more sub-states correlate with one or more partial failure states or resource specific failure states.

5. The method of claim 1, wherein each of said one or more CPEs is configurable to accept or decline traffic based on its state.

6. The method of claim 1, wherein said one or more states of said one or more CPEs are determined by sending one or more messages to said one or more CPEs.

7. The method of claim 6, wherein said one or more messages comprise one or more Session Initiation Protocol (SIP) Option requests.

8. The method of claim 1, wherein said one or more states are dynamically configured by said customer.

9. The method of claim 1, wherein said customer controlled traffic redistribution is provided by a network service provider as a subscriber service by said customer.

10. A computer-readable medium having stored thereon a plurality of instructions, the plurality of instructions including instructions which, when executed by a processor, cause the processor to perform the steps of a method for providing customer controlled traffic redistribution, comprising:
determining one or more states of one or more Customer Premise Equipments (CPEs) at one or more customer sites periodically, wherein said one or more states are configured by a customer;
determining a network action for each of said one or more CPEs in accordance with said one or more states of said one or more CPEs; and
routing traffic for the customer in accordance with said network action for each of said one or more CPEs.

11. The computer-readable medium of claim 10, wherein said one or more states comprise at least one of: an active state, a standby state or a failure state.

12. The computer-readable medium of claim 10, wherein said one or more states contain one or more sub-states.

13. The computer-readable medium of claim 12, wherein said one or more sub-states correlate with one or more partial failure states or resource specific failure states.

14. The computer-readable medium of claim 10, wherein each of said one or more CPEs is configurable to accept or decline traffic based on its state.

15. The computer-readable medium of claim 10, wherein said one or more states of said one or more CPEs are determined by sending one or more messages to said one or more CPEs.

16. The computer-readable medium of claim 15, wherein said one or more messages comprise one or more Session Initiation Protocol (SIP) Option requests.

17. The computer-readable medium of claim 10, wherein said one or more states are dynamically configured by said customer.

18. The computer-readable medium of claim 10, wherein said customer controlled traffic redistribution is provided by a network service provider as a subscriber service by said customer.

19. A system for providing customer controlled traffic redistribution, comprising:
means for determining one or more states of one or more Customer Premise Equipments (CPEs) at one or more customer sites periodically, wherein said one or more states are configured by a customer;
means for determining a network action for each of said one or more CPEs in accordance with said one or more states of said one or more CPEs; and
means for routing traffic for the customer in accordance with said network action for each of said one or more CPEs.

20. The system of claim 19, wherein said one or more states comprise at least one of: an active state, a standby state or a failure state.
